(19) United States
(12) Patent Application Publication
(10) Pub. No.: US 2006/0055991 A1
(43) Pub. Date: Mar. 16, 2006

(54) Image capture apparatus and image capture method

(75) Inventors: Jun Minakuti, Sakai-shi (JP); Yasushi Hasegawa, Sakai-shi (JP); Hiroaki Kubo, Muko-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/108,207

(22) Filed: Apr. 15, 2005

(30) Foreign Application Priority Data
Sep. 10, 2004 (JP) JP2004-263757

(51) Int. Cl. G03F 3/08

(52) U.S. Cl. 358/521; 358/530; 358/302

(57) ABSTRACT

A digital camera (10a) is placed in any of three photographing modes labeled a “narrow mode”, a “normal mode”, and a “wide mode”. An operating point setter (903) variably sets an operating point of a CCD (26) defining a brightness range of a subject which falls within a dynamic range of an image sensor, based on a photographing mode as set. A LUT setter (902) variably sets a gradation correction LUT which is a concrete representation of gradation correction characteristics in gradation correction performed by a γ correction circuit (55) (characteristics in γ correction), based on the photographing mode as set. The operating point set by the operating point setter (903) and the gradation correction LUT set by the LUT setter (902) are changed in synchronism with each other in accordance with change in the photographing mode.

This application is based on application No. 2004-263757 filed in Japan, the contents of which are hereby incorporated by reference.

### BACKGROUND OF THE INVENTION

1. Field of the Invention

The present invention relates to an image capture apparatus and an image capture method which allow proper photographing of various subjects having different brightness distributions.

2. Description of the Background Art

Conventionally, a digital camera which captures an image, creates image data of the captured image, performs predetermined image processing on the created image data, and then records the resultant image data, has been widely used.

In a typical digital camera, exposure control is usually exercised based on a brightness of a region of a subject where light metering is performed. However, the typical digital camera performs the exposure control or image processing without reflecting a brightness distribution of the subject. For this reason, in photographing a subject having a wide brightness distribution, the typical digital camera often failed to express gradation of a highlight portion (, so that the highlight portion is “washed out” as undifferentiated white). Also, in photographing a subject having a narrow brightness distribution, the typical digital camera often failed to express gradation of a shadow portion (, so that details in the shadow portion are eliminated as undifferentiated black), or reduced a signal-to-noise (SIN) ratio in the shadow portion.

In the meantime, a digital camera capable of controlling a brightness range within which photographing is possible is known, as taught by Japanese Patent Application Laid-Open No. 2004-120511 (which will hereinafter be referred to as “JP 2004-120511”). The digital camera taught by JP 2004-120511 varies a gain of an analog amplifier for amplifying an output signal of an image sensor and gradation correction characteristics, to thereby vary the brightness range of a subject within which photographing is possible.

The digital camera taught by JP 2004-120511, however, requires the analog amplifier to amplify an output signal of the image sensor in all modes except a mode in which the brightness range within which photographing is possible is largest. As such, a full dynamic range of the image sensor cannot be used. Also, the digital camera taught by JP 2004-120511 cannot avoid-degradation of a signal-to-noise ratio which occurs due to amplification of the analog amplifier. In short, the digital camera taught by JP 2004-120511 suffers from a problem of incapability of photographing various subjects having different brightness distributions under conditions suitable to the different brightness distributions, respectively.

### SUMMARY OF THE INVENTION

To overcome the foregoing problem, it is an object of the present invention to provide an image capture apparatus capable of properly photographing various subjects having different brightness distributions.

To attain the foregoing object, according to a first aspect of the present invention, an image capture apparatus includes: an image sensor for capturing an image; an operating point setter for variably setting an operating point of the image sensor which defines a brightness range of a subject which falls within a dynamic range of the image sensor; a gradation corrector for performing gradation correction for the image captured by the image sensor; and a gradation-correction characteristics setter for variably setting gradation-correction characteristics in the gradation correction. Also, in the apparatus, the operating point set by the operating point setter and the characteristics in the gradation correction which is set by the gradation-correction characteristics setter are changed in synchronism with each other.

The image capture apparatus makes it possible to change a brightness range of the subject within which photographing is possible, and to properly reproduce a portion having a standard brightness in the subject in an image provided after gradation correction. As a result, various subjects having different brightness distributions can be properly photographed.

According to a second aspect of the present invention, an image capture method includes: an operating point setting step of variably setting an operating point for setting an operating point of an image sensor used for image capture, which point defines a brightness range of a subject which falls within a dynamic range of the image sensor; a gradation-correction characteristics setting step of variably setting gradation-correction characteristics in gradation correction performed on an image is variable; an image capturing step of performing the image capture using the image sensor; and a gradation correcting step of performing the gradation correction on the image captured by the image sensor. Also, in the method, the operating point set in the operating point setting step and the gradation-correction characteristics in the gradation correction which is set in the gradation-correction characteristics setting step are changed in synchronism with each other.

The image capture method makes it possible to change a brightness range of the subject within which photographing is possible, and to properly reproduce a portion having a standard brightness in the subject in an image provided after gradation correction. As a result, various subjects having different brightness distributions can be properly photographed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an appearance of a digital camera 10a according to a preferred embodiment of the present invention.

FIG. 2 illustrates an internal structure of the digital camera 10a according to the preferred embodiment of the present invention.

FIG. 3 is a block diagram illustrating a structure of electric parts of the digital camera 10a according to the preferred embodiment of the present invention.

FIG. 4 is a diagram of functional blocks of the digital camera 10a which are involved in setting of a photographing mode, according to the preferred embodiment of the present invention.

FIG. 5 shows specific examples of an operating point and a gradation correction LUT.

FIG. 6 is a flow chart showing operations of the digital camera 10a according to the preferred embodiment of the present invention.

### DESCRIPTION OF THE PREFERRED EMBODIMENTS

A digital camera 10a according to a preferred embodiment of the present invention is an image capture apparatus which captures an image of a subject, creates image data of the captured image, performs predetermined image processing on the created image data, and then records the resultant image data.

The digital camera 10a can be placed in any of three photographing modes labeled a “narrow mode”, a “normal mode”, and a “wide mode”. The three photographing modes are different from one another in a brightness range of a subject within which photographing is possible (which will hereinafter be also referred to as a “photographing-permitted brightness range”). The digital camera 10a records an image such that each portion of a subject having a standard brightness (which portion will hereinafter be also referred to as a “standard brightness portion”) can have the same brightness in the recorded image, irrespective of the photographing mode. It is noted that the “photographing-permitted brightness range” means a brightness range within which gradation can be reproduced in a recorded image (a brightness range within which “washing-out” of a highlight portion and elimination of detail in a shadow portion can be prevented). That is, the “photographing-permitted brightness range” corresponds to a brightness range of a subject which falls within a dynamic range of an image sensor used for photographing. Also, the “standard brightness portion” corresponds to a portion having a predetermined reflectance, for example.

In the digital camera 10a, a photographing-permitted brightness range is varied as a result of a change in an operating point of an image sensor of the digital camera 10a. The operating point of the image sensor defines a brightness range of a subject which falls within a dynamic range of the image sensor. More specifically, in the digital camera 10a, exposure setting is adjusted so as to achieve underexposure, to reduce an output value of the image sensor for a standard brightness portion. In this manner, the photographing-permitted brightness range is expanded. Also, in the digital camera 10a, exposure setting is adjusted so as to achieve overexposure, to increase an output value of the image sensor for a standard brightness portion. In this manner, the photographing-permitted brightness range is narrowed. In other words, the digital camera 10a enhances a current sensitivity (i.e., currently-set sensitivity) of the image sensor which serves as a basis of exposure control, to thereby expand the photographing-permitted brightness range on one hand, and reduces the current sensitivity, to thereby narrow the photographing-permitted brightness range on the other hand.

Further, even though an output value of the image sensor for a standard brightness portion varies due to a change in an operating point of the image sensor, the digital camera 10a compensates for such variation by varying gradation correction characteristics in gradation correction. As a result, a standard brightness portion can have the same brightness in a recorded image in any of the three photographing modes, in the digital camera 10a.

Below, a structure and operations of the digital camera 10a briefly-mentioned above will be described.

Appearance

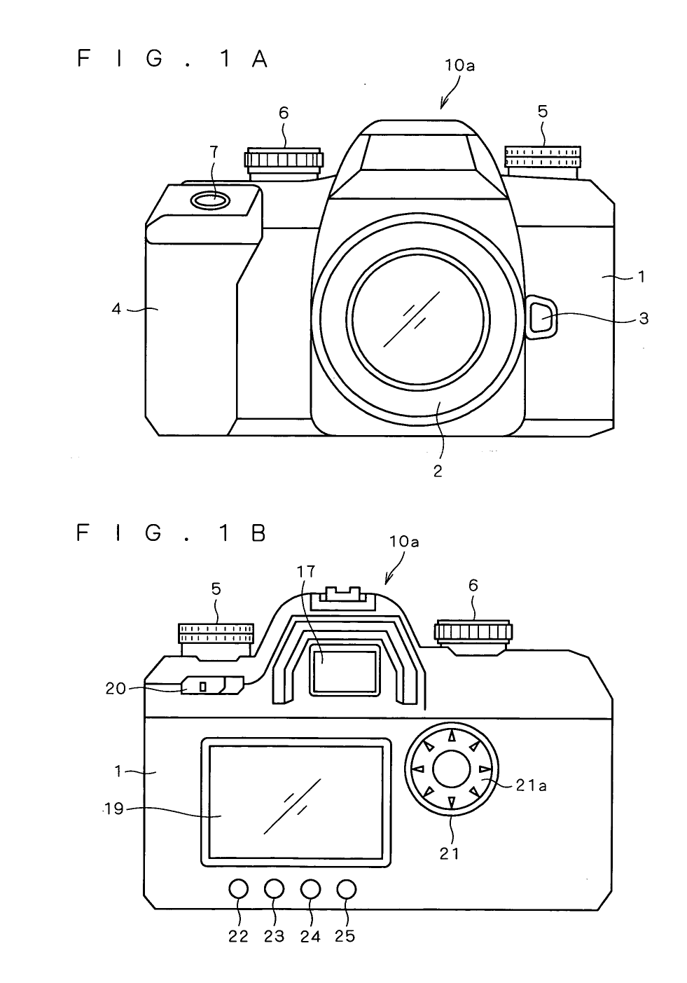

First, an appearance of the digital camera 10a according to the preferred embodiment of the present invention will be described. FIGS. 1A and 1B illustrate the appearance of the digital camera 10a. FIG. 1A is a front view of the digital camera 10a, and FIG. 1B is a back view of the digital camera 10a.

Referring to FIG. 1A, the digital camera 10a is a single lens reflex digital camera including a camera body 1 and a taking lens 2.

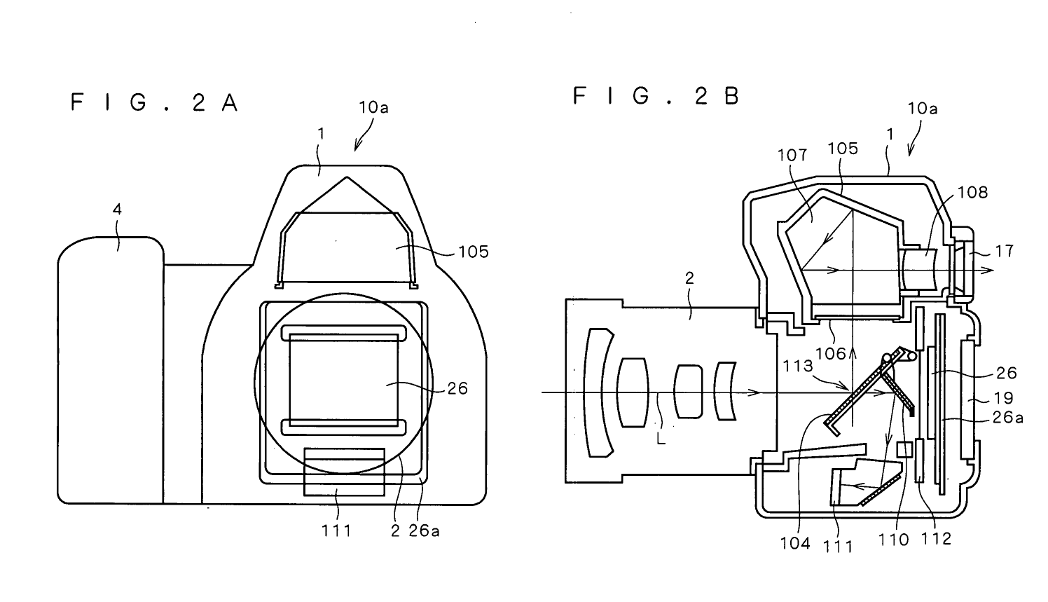

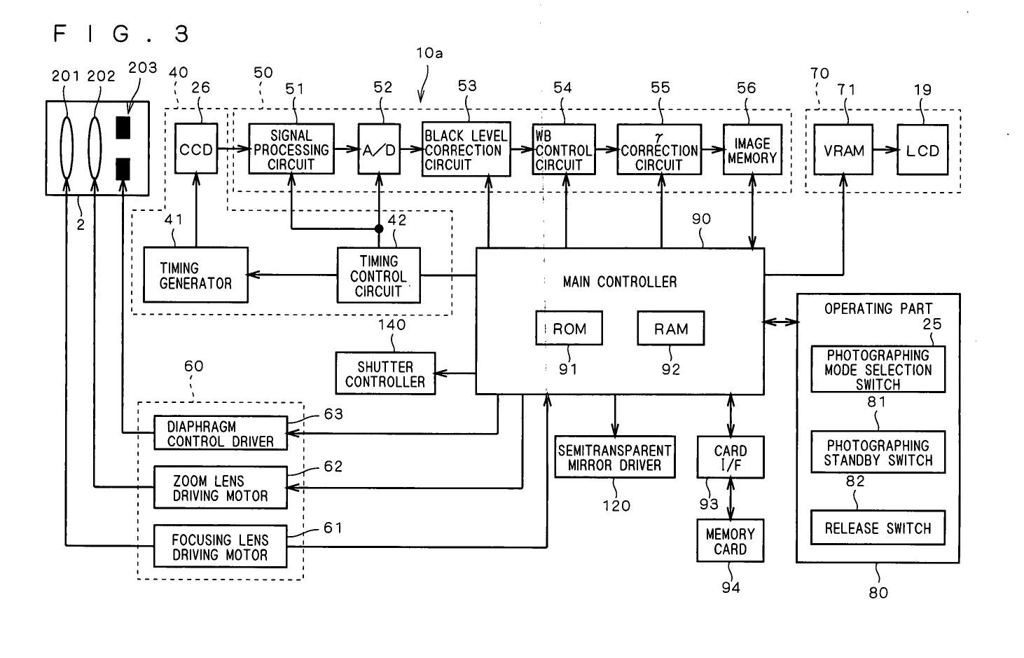

The taking lens 2 is exchangeable, and is attached to a mount (not illustrated) provided at the approximate center of a front face of the camera body 1. The taking lens 2 functions to form an image on a light receiving face of a CCD 26 (see FIGS. 2 and 3) from a light incident upon a front face of the digital camera 10a. In the digital camera 10a, the taking lens 2 is detachable from the camera body 1 upon a press of a detachment button 3 provided in the vicinity of the mount. Further, a plurality of electric contacts (not illustrated) for establishing electrical connection between the camera body 1 and the taking lens 2 and a plurality of couplers (not illustrated) for establishing mechanical connection between the camera body 1 and the taking lens 2 are provided in the vicinity of the mount.

A grip 4 for allowing a user to easily hold the camera body 1 is provided on the left-hand side in the front face of the digital camera 10a. A battery compartment and a memory card compartment are provided inside the grip 4. The battery compartment accommodates a battery (four AA batteries, for example) for supplying an operating power of the digital camera 10a. The memory card compartment accommodates a memory card 94 (see FIG. 3) serving as a recording medium for recording image data. Each of the battery in the battery compartment and the memory card in the memory card compartment is exchangeable with another. Also, a release button 7 is provided on a top face of the grip 4. The release button 7 is a two-position push button which can be placed in two discernable states of: a state in which the button 7 is pressed halfway down; and a state in which the button 7 is fully pressed down. As illustrated in FIGS. 1A and 1B, a control value selection dial 5 is provided on a top face of the digital camera 10a. The control value selection dial 5 is located on the right-hand side when viewed from the front. Also, a mode selection dial 6 is provided on the top face of the digital camera 10a, being located on the left-hand side when viewed from the front. The control value selection dial 5 is used for setting various control values of the digital camera 10a. The mode selection dial 6 is used for switching an operating mode of the digital camera 10a among a still image capture mode, a movie capture mode, and a playback mode.

Referring to FIG. 1B, a viewfinder 17 is provided at the approximate center of an upper portion of a back face of the digital camera 10a. An image of a subject captured by the taking lens 2 is guided to the viewfinder 17.

A liquid crystal display 19 is provided at the approximate center of the back face of the digital camera 10a. The liquid crystal display 19 is used for playing back a recorded image and displaying a menu for various settings.

A power switch 20 is provided at the upper left relative to the liquid crystal display 19. The power switch 20 is a two-position slide switch. Movement of a knob of the power switch 20 toward an OFF position on the left-hand side turns off the digital camera 10a, and movement of the knob of the power switch 20 toward an ON position on the right-hand side turns on the digital camera 10a.

A direction selection key 21 including a circular control button 21a is provided on the right side of the liquid crystal display 19. The direction selection key 21 can detect presses of a top position, a bottom position, a left position, a right position, an upper-right position, a lower-right position, an upper-left position, and a lower-left position of the control button 21a. The direction selection key 21 is allocated to a plurality of functions. For example, the direction selection key 21 is used for a change in choice of an item in the displayed menu, a change in choice of an image in a displayed index including arrangement of a plurality of thumbnail images, and a change in zoom magnification of the taking lens 2.

Moreover, a cancellation switch 22, a confirmation switch 23, a menu display switch 24, and a photographing mode selection switch 25 are provided below the liquid crystal display 19. The cancellation switch 22 and the confirmation switch 23 are push-button switches for respectively supplying instructions for cancellation and confirmation of each choice which is made in the displayed menu, to the digital camera 10a. The menu display switch 24 is used for calling up the menu on the liquid crystal display 19, and also for switching contents of the menu as called up. The photographing mode selection switch 25 is used for selecting one of the narrow mode, the normal mode, and the wide mode, as a photographing mode of the digital camera 10a.

Internal Structure

Next, an internal structure of the digital camera 10a will be described. FIGS. 2A and 2B illustrate the internal structure of the digital camera 10a. FIG. 2A is a perspective view of the digital camera 10a when viewed from the front. FIG. 2B is a sectional view of the digital camera 10a when viewed from the side.

Referring to FIG. 2B, the CCD 26 functioning as the image sensor of the digital camera 10a is provided in an appropriate position backward from the taking lens 2. The CCD 26 is mounted on a substrate 26a. The light receiving face of the CCD 26 and an optical axis L of the taking lens 2 cross each other at right angles. Light sensing cells each as one unit for photoelectric conversion are arranged on the light receiving face of the CCD 26 in both a vertical direction and a horizontal direction (1200 (pixels in a vertical direction)×1600 (pixels in a horizontal direction), for example). Any of a red (R) color filter, a green (G) color filter, and a blue (B) color filter, is disposed on a surface of each of the light sensing cells. A color component of a pixel signal which is output from one of the light sensing cells as a result of photoelectric conversion corresponds to a color of the color filter disposed on the one light sensing cell, and the same is true for all pixel signals output from the other light sensing cells. The R, G, B color filters are arranged in a so-called Bayer pattern. It is additionally noted that a CMOS image sensor or a VMIS image sensor may be employed as the image sensor, in place of the CCD 26.

A shutter 112 is provided in front of the CCD 26. The shutter 112 is a focal plane shutter with vertical slots.

Further, a quick return mirror 113 including a semitransparent mirror 104 and a sub mirror 110 is provided in front of the shutter 112.

As illustrated in FIG. 2B, the semitransparent mirror 104 reflects a part of an incident light received from the taking lens 2, to form an image on a focusing glass 106, and also transmits the remaining part of the incident light and guides the transmitted part of the incident light to the sub mirror 110 situated backward from the semitransparent mirror 104, in standby conditions. The part of the light guided to the sub mirror 110 is further reflected by the sub mirror 110, and then guided to a focus detector 111. The focus detector 111 detects a state of a focus, in other words, detects what degree focusing is achieved. The semitransparent mirror 104, together with the sub mirror 110, is flipped upward to be retained in a retracted position just under the focusing glass 106 during exposure of the CCD 26. While the semitransparent mirror 104 is being located in the retracted position, an incident light is guided to the light receiving face of the CCD 16.

The digital camera 10a further includes a finder optical system 105 for guiding an image of a subject which is formed on the focusing glass 106 to the outside of the viewfinder 17. The finder optical system 105 includes a pentagonal roof prism 107 and an eyepiece lens 108. The pentagonal roof prism 107 reflects an image of a subject formed on the focusing glass 106 and guides the reflected image to the eyepiece lens 108, which then further guides the image of the subject to the outside of the viewfinder 17.

Structure of Electric Parts

Next, a structure of electric parts of the digital camera 10a will be described. FIG. 3 is a block diagram illustrating the structure of electric parts of the digital camera 10a.

Referring to FIG. 3, the digital camera 10a includes the taking lens 2, an image capture part 40, a signal processor 50, a lens controller 60, a display part 70, an operating part 80, a main controller 90, a semitransparent mirror driver 120, a shutter controller 140, and the like, as the electric parts thereof.

Taking Lens

The taking lens 2 includes a focusing lens 201 for changing a state of a focus, a zoom lens 202 for changing a zoom magnification, and a diaphragm 203 for changing an amount of light incident upon the CCD 26. The taking lens 2 further includes a ROM for lens (not illustrated) storing information peculiar to the taking lens 2 (such as information about a minimum f-number provided when an aperture of the diaphragm 203 is saturated, a focal length, and the like). In the digital camera 10a, the information stored in the ROM for lens is sent to the main controller 90 via the above-mentioned electric contacts, and also, information about locations of the focusing lens 201 and the zoom lens 202 included in the taking lens 2 is sent to the main controller 90. Further, driving forces of a focusing lens driving motor 61 and a zoom lens driving motor 62 both of which will be later described, are transferred to the focusing lens 201 and the zoom lens 202, respectively, via the above-mentioned couplers, in the digital camera 10a.

Image Capture Part

The image capture part 40 performs photoelectric conversion on an image of a subject formed on the light receiving face of the CCD 26, and generates an image signal of the captured image. The image capture part 40 includes the CCD 26, a timing generator 41, and a timing control circuit 42.

The CCD 26 performs exposure (i.e., storage of electric charges through photoelectric conversion) of an image of a subject formed on the light receiving face thereof, in response to a drive control signal (a signal for starting storage, a signal for ending storage) input from the timing generator 41, to generate an image signal of the image of the subject. Further, the CCD 26 outputs the image signal to the signal processor 50, in response to a readout control signal (a horizontal synchronization signal, a vertical synchronization signal, a transfer signal, and the like) input from the timing generator 41. That is, the CCD 26 captures an image of a subject, and outputs an image signal of the captured image to the signal processor 50.

A level (output value) of one of pixel signals forming the image signal output from the CCD 26 is proportional to an amount of light incident upon one of the light sensing cells which has generated the one pixel signal, within the dynamic range of the CCD 26. The same is true for all the pixel signals. However, if one of the light sensing cells receives light in an amount which exceeds the dynamic range of the CCD 26, increase in amount of the light incident upon the one light sensing cell would not result in increase in the level of the corresponding pixel signal output from the one light sensing cells, because the level of the pixel signal is maximized. Then, if exposure conditions such as a shutter speed and an f-number are constant, a brightness range of a subject which falls within the dynamic range of the CCD 26 is constant.

The timing generator 41 generates the drive control signal based on a photographing control signal input from the timing control circuit 42, and generates the readout control signal based on a reference clock signal input from the timing control circuit 42, to output the generated drive control signal and the generated readout control signal to the CCD 26.

The timing control circuit 42 generates the photographing control signal based on a control signal input from the main controller 90. The photographing control signal includes a control signal for displaying moving images of a subject on the liquid crystal display 19 in the movie capture mode, a control signal for capturing a still image of a subject in the still image capture mode, the reference clock signal, a timing signal (synchronization clock signal) for performing signal processing on an image signal output from the CCD 26 in the signal processor 50, and the like. The timing signal is input to an analog signal processing circuit 51 and an analog-to-digital (A/D) conversion circuit 52 of the signal processor 50.

Signal Processor

The signal processor 50 performs predetermined analog signal processing and digital signal processing on an image signal supplied from the CCD 26. The signal processor 50 performs signal processing on pixel signals forming an image signal, one by one. The signal processor 50 includes the analog signal processing circuit 51, the A/D conversion circuit 52, a black level correction circuit 53, a white balance (WB) control circuit 54, a γ correction circuit 55, and an image memory 56. Out of those parts included in the signal processor 50, the black level correction circuit 53, the white balance (WB) control circuit 54, and the γ correction circuit 55 are allocated to digital signal processing.

The analog signal processing circuit 51 performs analog signal processing on an analog image signal supplied from the CCD 26. More specifically, the analog signal processing circuit 51 includes a correlated double sampling (CDS) circuit for lowering a sampling noise of an image signal and an automatic gain control (AGC) circuit for controlling a level of an image signal. The AGC circuit also functions to compensate for insufficiency in level of a captured image under a situation where proper exposure cannot be achieved because of a controlled aperture of the diaphragm 203 in the taking lens 2 and a controlled exposure time of the CCD 26, in photographing a subject having an extremely low brightness. Additionally, how much gain the AGC circuit allows is determined by the main controller 90.

The A/D conversion circuit 52 converts an analog image signal output from the analog signal processing circuit 51 to a digital image signal (which will hereinafter be also referred to as “image data”). The A/D conversion circuit 52 converts a pixel signal output from each of the light sensing cells to 12-bit pixel data, for example.

The black level correction circuit 53 corrects a black level of each pixel data forming image data which is output from the A/D conversion circuit 52 so that the black level of each pixel data is equal to a reference black level.

The WB control circuit 54 exercises white balance control of an image. More specifically, the WB control circuit 54 converts a level of pixel data of each of the color components R, G, and B, using a level conversion table supplied from the main controller 90, to achieve white balance control. Respective conversion coefficients of the color components which are included in the level conversion table are supplied from the main controller 90 for each captured image.

The γ correction circuit 55 performs gradation correction on an image captured by the CCD 26. More specifically, the γ correction circuit 55 performs γ correction on each pixel data forming image data, using a γ correction table which is held as a look up table for gradation correction (gradation correction LUT). In γ correction performed by the γ correction circuit 55, 12-bit pixel data as received is converted to a 8-bit (256 gradation levels) pixel data, and output. The γ correction circuit 55 is allowed to use a plurality of gradation correction tables in γ correction. Which one of the plurality of γ correction tables should be actually used in γ correction is determined by the main controller 90.

The image memory 56 functions to temporarily store image data which has been subjected to signal processing. The image memory 56 has a capacity which allows recording of a plurality of frames of image data.

Lens Controller

The lens controller 60 includes the focusing lens driving motor 61, the zoom lens driving motor 62, and a diaphragm control driver 63.

The focusing lens driving motor 61 moves the focusing lens 201 based on an automatic focus (AF) control signal input from the main controller 90.

The zoom lens driving motor 62 moves the zoom lens 202 based on a zoom control signal input from the main controller 90. More specifically, the digital camera 10a shifts the zoom lens 202 to a telephoto side upon detection of a press of the right position of the control button 21a, and shifts the zoom lens 202 to a wide angle side upon detection of a press of the left position of the control button 21a.

The diaphragm control driver 63 sets an f-number of the diaphragm 203 to a value input from the main controller 90.

Display Part

The display part 70 includes the liquid crystal display 19 and a VRAM 71.

The liquid crystal display 19 is a rectangular color display including 400 (in a horizontal direction)×300 (in a vertical direction) pixels, for example.

The VRAM 71 is a buffer memory for storing image data of an image displayed on the liquid crystal display 19.

Controller

The operating part 80 includes a photographing standby switch 81 which is turned on in response to the release button 7 being pressed halfway down, and a release switch 82 which is turned on in response to the release button 7 being fully pressed down. The operating part 80 further includes the control value selection dial 5, the mode selection dial 6, the direction selection key 21, the cancellation switch 22, the confirmation switch 23, the menu display switch 24, and the photographing mode selection switch 25. However, only the photographing standby switch 81, the release switch 82, and the photographing mode selection switch 25 out of all the foregoing parts are illustrated in FIG. 3. A state of the operating part 80 is detected by the main controller 90.

Main Controller and Others

The main controller 90 is a microcomputer including a ROM 91 and a RAM 92. The main controller 90 controls each of all parts of the digital camera 10a in accordance with a control program stored in the ROM 91. The RAM 92 temporarily stores various data for calculations, control operations, and the like.

The main controller 90 is connected with the memory card 94 via a card interface (card I/F) 93. The card I/F 93 is an interface through which image data is written into, and read out from, the memory card 94.

A semitransparent mirror driver 120 retracts the semitransparent mirror 104 to the foregoing retracted position in response to a retraction signal input from the main controller 90. The retraction signal is generated by the main controller 90 at the time of exposure of the CCD 26.

In the still image capture mode, the main controller 90 starts preparations for photographing such as automatic focus control, automatic exposure control, and the like, upon detecting that the photographing standby switch 81 is turned on. Then, upon detecting that the release switch 82 is turned on, the main controller 90 initiates a principal operation for photographing. That is, an image of a subject is captured, image data of the capture image is created, predetermined image processing is performed on the image data, and the resultant image data is recorded in the memory card 94.

In the movie capture mode, the main controller 90 initiates a principal operation for photographing, upon detecting that the release switch 82 is turned on. Then, the main controller 90 ends a principal operation for photographing, upon detecting that the release switch 82 is again turned on during the principal operation for photographing.

Functions

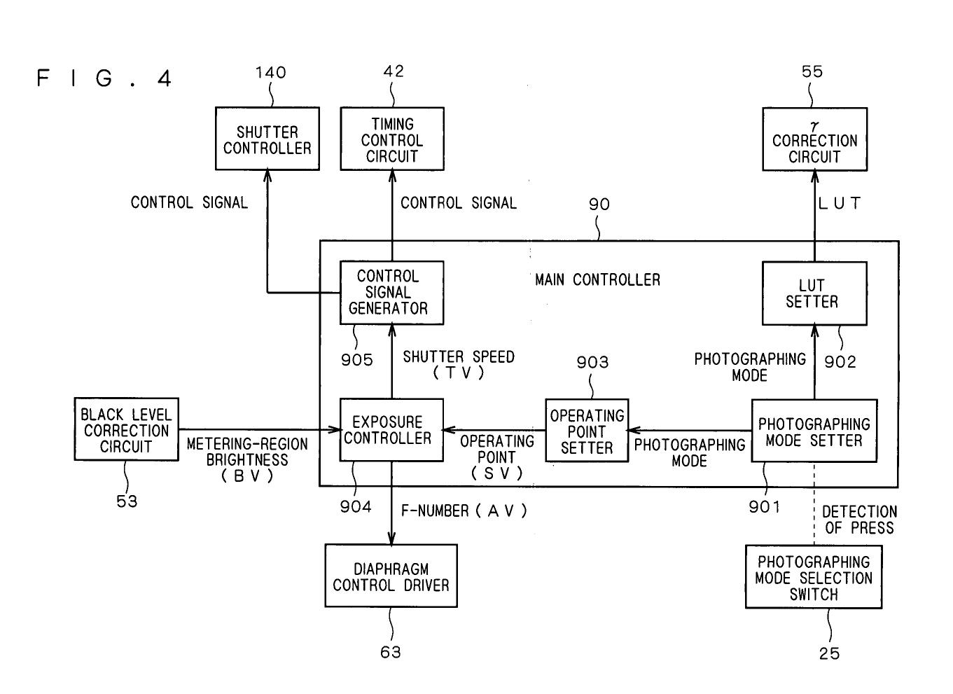

Below, a configuration of functional blocks of the digital camera 10a which are involved in setting of the photographing mode will be described with reference to a block diagram in FIG. 4. A photographing mode setter 901, a LUT setter 902, an operating point setter 903, an exposure controller 904, and a control signal generator 905 in FIG. 4 are functional blocks which implement functions upon execution of a control program stored in the ROM 91 by the main controller 90 which is a microcomputer.

The photographing mode setter 901 detects a press of the 6photographing mode selection switch 25, and sets a photographing mode to one of the narrow mode, the normal mode, and the wide mode, based on a result of the detection. More specifically, the photographing mode setter 901 switches a photographing mode among the narrow mode, the normal mode, and the wide mode sequentially and cyclically, upon detection of a press of the photographing mode selection switch 25. The resultant setting of the photographing mode is notified to the operating point setter 903 and the LUT setter 902.

The operating point setter 903 variably sets an operating point of the CCD 26 to a given value based on the photographing mode set by the photographing mode setter 901. More specifically, the operating point setter 903 sets a current sensitivity which is one representation of an operating point, to 50, 100, and 200 in cases a photographing mode is set to the narrow mode, the normal mode, and the wide mode, respectively. It is noted that a current sensitivity means ISO sensitivity, and such meaning will be true in later description. Also, a current sensitivity can be converted into SV according to Additive System of Photographic Exposure (APEX), and the sensitivities of 50, 100, and 200 correspond to SVs of 4, 5, and 6, respectively. Thus, a current sensitivity serves as a basis for exposure control, in other words, a basis for calculation of an f-number and a shutter speed. As such, a current sensitivity does not necessarily correspond to an actual sensitivity of the CCD 26. Accordingly, in the digital camera 10a, a gain allowed by the AGC circuit included in the signal processing circuit 51 does not increase even with increase of a current sensitivity. In other words, in the digital camera 10a, even if a current sensitivity is changed to change a photographing-permitted brightness range, degradation of signal-to-noise ratio which is likely to occur due to amplification of the analog amplifier does not occur. Additionally, by setting a current sensitivity in the normal mode to the same value of the actual sensitivity of the CCD 26, a user can perform photographing as if the user uses an ordinary digital camera, in the normal mode.

The LUT setter 902 variably sets a gradation correction LUT which is a concrete representation of gradation correction characteristics in gradation correction performed by the γ correction circuit 55 (i.e., γ correction characteristics in γ correction), to a given LUT, based on the photographing mode set by the photographing mode setter 901. More specifically, the LUT setter 902 sets a gradation correction LUT to a narrow-mode gradation correction LUT, a normal-mode gradation correction LUT, and a wide-mode gradation correction LUT in cases where a photographing mode is set to the narrow mode, the normal mode, and the wide mode, respectively. Each of those gradation correction LUTs is controlled such that a brightness that a standard brightness portion in an image would have after gradation correction can be kept constant even with change in an operating point. As a result, the standard brightness portion can be properly reproduced with the same brightness in the image after gradation correction in each of the three photographing modes.

The photographing mode setter 901, the operating point setter 903, and the LUT setter 902 operate such that the operating point and the gradation correction LUT which are set by the operating point setter 903 and the LUT setter 902, respectively, are changed in synchronism with a change in a photographing mode.

The exposure controller 904 determines an f-number and a shutter speed, based on an operating point of the CCD 26, that is, a current sensitivity, and a brightness of a region established in a captured image of a subject, where light metering is performed (which brightness will hereinafter be also referred to as a “metering-region brightness”). An operating point of the CCD 26 is obtained from the operating point setter 903, and a metering-region brightness is obtained from the black level correction circuit 53. A relationship among a current sensitivity, a metering-region brightness, an f-number, and a shutter speed is represented by the following conditional expression (Expression 1) for achieving proper exposure. In the Expression 1, “SV”, “BV”, “AV”, and “TV” are units according to APEX, respectively for the current sensitivity, the metering-region brightness, the f-number, and the shutter speed. Also, the exposure controller 904 refers to a program line stored in the digital camera 10a in determining values of an f-number and a shutter speed. Additionally, the metering-region brightness can alternatively be obtained from a sensor for light metering which is provided additionally to the CCD 26.
SV+BV=AV+TV Expression 1

The f-number and the shutter speed which are determined by the exposure controller 904 are output to the diaphragm control driver 63 and the control signal generator 905, respectively. The control signal generator 905 generates a control signal for implementing the input shutter speed, and outputs the generated control signal to the shutter controller 140 and the timing control circuit 42. As a result, photographing with the f-number and the shutter speed determined by the exposure controller 904 becomes feasible.

In the digital camera 10a, exposure control allows change in brightness range of a subject which falls within the dynamic range of the CCD 26. That is, in the digital camera 10a, when a current sensitivity is set to a relatively high value to increase a sum of AV and TV which are respective units according to APEX for an f-number and a shutter speed (in other words, when exposure setting is adjusted so as to achieve underexposure), a brightness range of a subject which falls within the dynamic range of the CCD 26 is expanded. Conversely, when a current sensitivity is set to a relatively low value to reduce a sum of AV and TV which are respective units according to APEX for an f-number and a shutter speed (in other words, when exposure setting is adjusted so as to achieve underexposure), a brightness range of a subject which falls within the dynamic range of the CCD 26 is narrowed, in the digital camera 10a. Since a photographing-permitted brightness range is changed as a result of exposure control, the photographing-permitted brightness range can be changed even if the dynamic range of the CCD 26 is fixed. Hence, the digital camera 10a capable of varying a photographing-permitted brightness range can be easily constructed.

Operating Point and Gradation Correction LUT

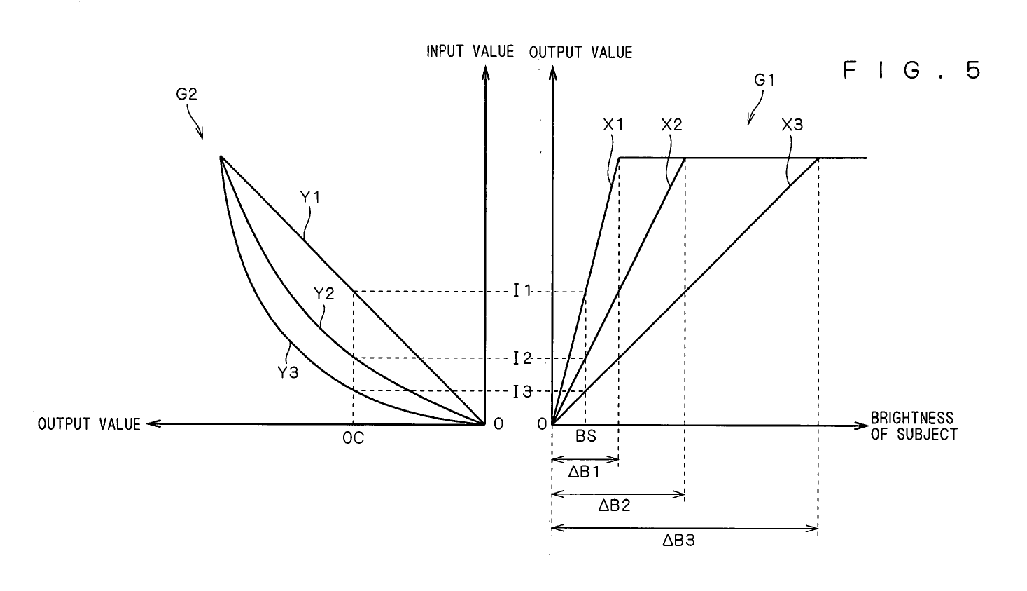

Below, specific examples of an operating point and a gradation correction LUT will be described with reference to FIG. 5. A graph G1 in FIG. 5 shows relationships each between a brightness of a subject and an output value of the CCD 26, and a graph G2 in FIG. 5 shows relationships each between an input value and an output value of the γ correction circuit 55. The graph G1 includes: a line X1 representing a relationship between a brightness of a subject and an output value of the CCD 26 in a case where a current sensitivity is set to 50 by the operating point setter 903; a line X2 representing a relationship between a brightness of a subject and an output value of the CCD 26 in a case where a current sensitivity is set to 100 by the operating point setter 903; and a line X3 representing a relationship between a brightness of a subject and an output value of the CCD 26 in a case where a current sensitivity is set to 200 by the operating point setter 903. The graph G2 includes; a line Y1 representing a relationship between an input value and an output value of the γ correction circuit 55 in a case where a gradation correction LUT is set to the narrow-mode gradation correction LUT by the LUT setter 902; a line Y2 representing a relationship between an input value and an output value of the γ correction circuit 55 in a case where a gradation correction LUT is set to the normal-mode gradation correction LUT by the LUT setter 902; and a line Y3 representing a relationship between an input value and an output value of the γ correction circuit 55 in a case where a gradation correction LUT is set to the wide-mode gradation correction LUT by the LUT setter 902. In FIG. 5, a vertical axis (representing an output value of the CCD 26) of the graph G1 and a vertical axis (representing an input value of the γ correction circuit 55) of the graph G2 are drawn to scale.

As shown by the graph G1, as a current sensitivity is changed from 50 to 100 to 200, a brightness range of a subject within which an output value of the CCD 26 can be increased in response to increase in brightness of the subject, in other words, a brightness range of a subject which falls within the dynamic range of the CCD 26, is increased from ΔB1 to ΔB2 to ΔB3. On the other hand, as a current sensitivity is changed from 50 to 100 to 200, an output value of the CCD 26 provided in response to provision of the same reference brightness BS is decreased from I1 to I2 to I3. Accordingly, prior to processing being performed by the γ correction circuit 55, a standard brightness portion in a recorded image becomes darker as a photographing-permitted brightness range is expanded.

view of the foregoing, the plurality of gradation correction LUTs having different γ values (the narrow-mode gradation correction LUT, the normal-mode gradation correction LUT, and the wide-mode gradation correction LUT) are prepared in the digital camera 10a. The plurality of gradation correction LUTs having different γ values allow the CCD 26 to provide a constant output value OC in response to reception of different input values I1, I2, and I3, to thereby compensate for reduction in brightness of a standard brightness portion due to expansion of a photographing-permitted brightness range.

Additionally, as is made clear from the graph G2, as long as a brightness is relatively low, close to an original point O, an increment of an output value responsive to a given increment of an input value is largest when where the narrow-mode gradation correction LUT is selected and is smallest when the wide-mode gradation correction LUT is selected. For this reason, in the digital camera 10a, as the photographing-permitted brightness range is expanded, a noise is more strongly emphasized, to degrade a signal-to-noise ratio.

Owing to the above-described features, when a subject has a narrow brightness distribution, to set a photographing mode to the narrow mode allows proper expression of gradation in a recorded image, as well as suppresses a noise. On the other hand, when a subject has a wide brightness distribution, to set a photographing mode to the wide mode allows proper expression of gradation in a recorded image while possibly causing disadvantages associated with a noise. That is, the digital camera 10a is capable of properly photographing various subjects having different brightness distributions, taking into consideration the different brightness distributions, respectively. Further, since a photographing mode is selectable by using the photographing mode selection switch in the digital camera 10a, a user can cause the digital camera 10a to perform proper photographing taking into consideration a brightness range of each subject, by selecting a photographing mode depending on the brightness range of the subject.

It is noted that the relationships shown in the graph G1 are obtained by keeping a metering-region brightness at a specific value. As a metering-region brightness becomes lower, an increment of an output value of the CCD 26 responsive to a given increment of a brightness of a subject within the dynamic range of the CCD 26 is increased. On the other hand, as a metering-region brightness becomes higher, an increment of an output value of the CCD 26 responsive to a given increment of a brightness of a subject within the dynamic range of the CCD 26 is decreased. Nonetheless, the same relationship among the lines X1, X2, and X3 as shown in the graph G1 is maintained.

Operations

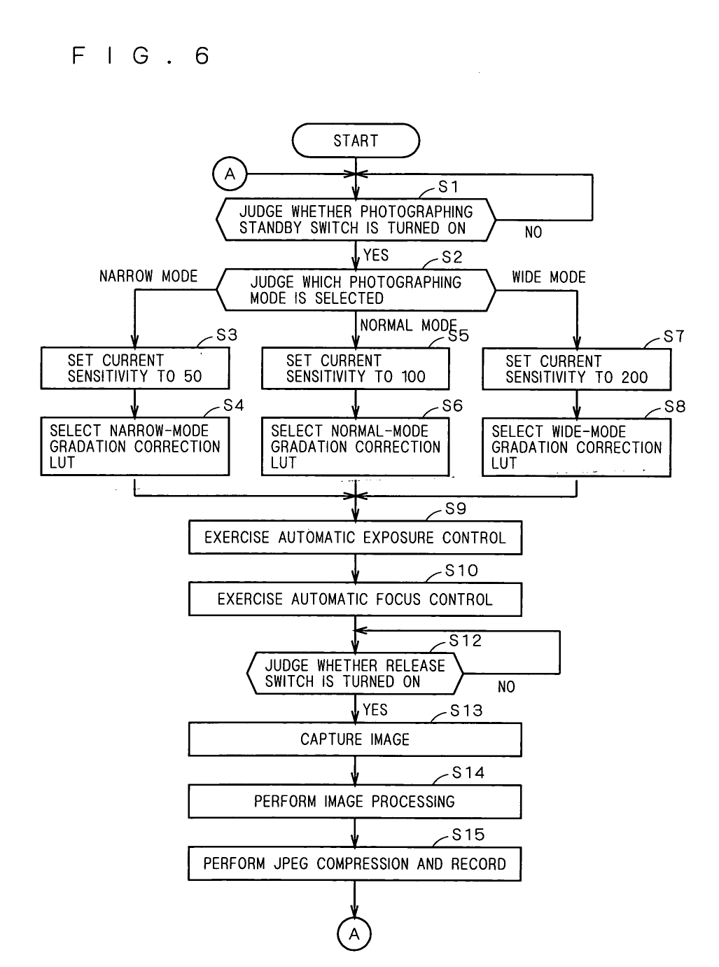

Next, operations of the digital camera 10a will be described with reference to a flow chart of FIG. 6.

First, a state of the photographing standby switch 81 is detected in standby conditions (step S1). In the step S1, if an ON state of the photographing standby switch 81 is detected, an operation flow goes to a step S2, where preparations for photographing are started. On the other hand, if an OFF state of the photographing standby switch 81 is detected, the operation flow returns back to the step S1, where detection of the state of the photographing standby switch 81 is repeated.

Steps S2 through S11 are a group of steps applied to preparations for photographing. In the step S2, branching is performed based on the photographing mode set by the photographing mode setter 901. More specifically, when a photographing mode is set to the narrow mode in the step S2, the operating point setter 903 sets a current sensitivity to 50 (step S3), and the LUT setter 902 sets a gradation correction LUT to the narrow-mode gradation correction LUT (in other words, selects the narrow-mode correction LUT) (step S4). When a photographing mode is set to the normal mode in the step S2, the operating point setter 903 sets a current sensitivity to the same value of the actual sensitivity of the CCD 26, i.e., 100 (step S5), and the LUT setter 902 sets a gradation correction LUT to the normal-mode gradation correction LUT (in other words, selects the normal-mode gradation correction LUT) (step S6). When a photographing mode is set to the wide mode in the step S2, the operating point setter 903 sets a current sensitivity to 200 (step S7), and the LUT setter 902 sets a gradation correction LUT to the wide-mode gradation correction LUT (in other words, selects the wide-mode gradation correction LUT) (step S8). After those settings in the steps S3 through S8, the operating point and the gradation correction LUT are changed in synchronism with each other. This makes a photographing-permitted brightness range variable, and allows a standard brightness portion to be properly reproduced in an image after gradation correction. Accordingly, various subjects having different brightness distributions can be properly photographed.

After the step S4, S6, or S8, the exposure controller 904 determines an f-number and a shutter speed based on the operating point and the metering-region brightness as set, in the digital camera 10a. Then, an f-number and a shutter speed are set as determined by the exposure controller 904 in automatic exposure control (step S9). Thereafter, the focusing lens driving motor 61 exercises automatic focus control in which the focusing lens 201 is moved to an in-focus position (step S10).

After the step S10, a state of the release switch 82 is detected in a step S12. In the step S12, if an ON state of the release switch 82 is detected, the operation flow goes to the step S13, where a principal operation for photographing is started. On the other hand, if an OFF state of the release switch 82 is detected in the step S12, the operation flow returns back to the step S12, where detection of a state of the release switch 82 is repeated.

Steps S13, S14 and S15 are a group of steps applied to a principal operation for photographing.

In the step S13, a control signal for exposure is output from the control signal generator 905 to the timing control circuit 42 and the shutter controller 140. Then, an image is captured by the CCD 26, and an image signal of the captured image is output to the signal processor 50.

The signal processor 50 performs image processing on the input image signal (step S14). Image data which has been subjected to the image processing by the signal processor 50 is then subjected to JPEG compression in the main controller 90, and subsequently is recorded in the memory card 94 (step S15). Thereafter, the operation flow returns back to the step S1.

Modifications

With Respect to Image Sensor

According to the above-described preferred embodiment, an output value of the CCD 26 is proportional to an amount of incident light within the dynamic range of the CCD 26. Alternatively, a sensor having nonlinear characteristics, such as a sensor which provides an output value proportional to a logarithm of an amount of incident light, may be employed as an image sensor. Also in this alternative embodiment, by setting a gradation correction LUT such that change in brightness of a standard brightness portion due to change in a photographing-permitted brightness range can be compensated for, it is possible to produce the same effects as produced in the above-described preferred embodiment.

With Respect to Setting of Photographing Mode

In the above-described preferred embodiment, an example in which a photographing mode is selected manually using the photographing mode selection switch 25 has been given. Alternatively, a photographing mode may be automatically selected. To this end, first, a brightness range of a subject is measured using the CCD 26 or a light-metering sensor provided additionally to the CCD 26, and then a photographing mode which allows the subject having the measured brightness range to be properly photographed is automatically selected by the digital camera 10a, for example. Otherwise, in a situation where it is found after capturing an image that the captured image includes a region having a brightness range beyond the dynamic range of the CCD 26, a photographing-permitted brightness range may be automatically expanded.

With Respect to Gradation Correction

According to the above-described preferred embodiment, gradation correction (γ correction) is performed within the digital camera 10a. Alternatively, gradation correction may be performed in an apparatus external to the digital camera 10a. In this alternative embodiment, it is desired that image data on which gradation correction should not be performed and a photographing mode which is set during obtainment of the corresponding image data are recorded in association with each other in the memory card 94.

While the invention has been shown and described in detail, the foregoing description is in all aspects illustrative and not restrictive. It is therefore understood that numerous modifications and variations can be devised without departing from the scope of the invention.

What is claimed is:

1. An image capture apparatus comprising:
an image sensor for capturing an image;
an operating point setter for variably setting an operating point of said image sensor, said operating point defining a brightness range of a subject which falls within a dynamic range of said image sensor;
a gradation corrector for performing gradation correction for said image captured by said image sensor; and
a gradation-correction characteristics setter for variably setting gradation-correction characteristics in said gradation correction, wherein said operating point set by said operating point setter and said characteristics in said gradation correction which is set by said gradation-correction characteristics setter are changed in synchronism with each other.

2. The image capture apparatus according to claim 1, further comprising
an exposure controller for performing exposure control based on said operating point set by said operating point setter, wherein
said brightness range of said subject which falls within said dynamic range of said image sensor is changed as a result of said exposure control.

3. The image capture apparatus according to claim 1, wherein
said gradation-correction characteristics setter sets said gradation-correction characteristics in said gradation correction such that a predetermined brightness of said subject is reproduced in the same way in an image provided after said gradation correction, irrespective of said operating point.

4. The image capture apparatus according to claim 1, further comprising
a photographing mode setter for setting a photographing mode for a brightness range of said subject within which photographing is possible, wherein
said operating point setter sets said operating point based on said photographing mode set by said photographing mode setter.

5. An image capture method comprising:
an operating point setting step of variably setting an operating point of an image sensor used for image capture, said operating point defining a brightness range of a subject which falls within a dynamic range of said image sensor;
a gradation-correction characteristics setting step of variably setting gradation-correction characteristics in gradation correction performed on an image is variable;
an image capturing step of performing said image capture using said image sensor; and
a gradation correcting step of performing said gradation correction on said image captured by said image sensor, wherein
said operating point set in said operating point setting step and said gradation-correction characteristics in said gradation correction which is set in said gradation-correction characteristics setting step are changed in synchronism with each other.

6. The image capture method according to claim 5, further comprising
an exposure controlling step of performing exposure control based on said operating point set in said operating point setting step, wherein
said brightness range of said subject which falls within said dynamic range of said image sensor is changed as a result of said exposure control.

7. The image capture method according to claim 5, wherein
said gradation-correction characteristics in said gradation correction is set such that a predetermined brightness of said subject is reproduced in the same way in an image provided after said gradation correction, irrespective of said operating point, in said gradation-correction characteristics setting step.

8. The image capture method according to claim 5, further comprising
a photographing mode setting step of setting a photographing mode for a brightness range of said subject within which photographing is possible, wherein
said operating point is set based on said photographing mode set in said photographing mode setting step, in said operating point setting step.
